(19) United States
(12) Patent Application Publication
(10) Pub. No.: US 2014/0170265 A1
(43) Pub. Date: Jun. 19, 2014

(54) INFANT FORMULA CUBES

(71) Applicant: MEAD JOHNSON NUTRITION COMPANY, Glenview, IL (US)

(72) Inventor: Wilfred L. Castillo, Newburgh, IN (US)

(73) Assignee: MEAD JOHNSON NUTRITION COMPANY, Glenview, IL (US)

(21) Appl. No.: 13/719,703

(22) Filed: Dec. 19, 2012

(51) Int. Cl. A23C 9/18

(52) U.S. Cl. CPC A23C 9/18
USPC 426/61; 426/590; 426/588; 426/71; 426/455

(57) ABSTRACT

The present disclosure provides nutritional compositions in a compressed solid form comprising about 21 to about 35% by weight of protein, about 20 to about 30% by weight percent of fat, and about 40 to about 60% by weight percent of carbohydrate, wherein the porosity of the compressed solid is less than about 30% or greater than about 60%, and the compressed solid has a moisture level of greater than 40%. The nutritional compositions, in certain embodiments, are resistant to breakage during transport and packaging, while remaining readily dissolvable upon contact with a liquid. The disclosure further provides process for preparing a nutritional composition in a compressed solid form comprising contacting a powdered nutritional composition with steam, and compressing the powdered nutritional composition under a pressure of less than 400 psi.

### TECHNICAL FIELD

The present disclosure relates to nutritional compositions in a compressed solid form, particularly infant and children's formulas. The compressed solid nutritional compositions provide a convenient form compared to powdered or liquid compositions. The present disclosure also relates to processes for preparing nutritional compositions in a compressed solid form.

### BACKGROUND

Nutritional compositions, such as infant formula and growing-up milks, are typically provided as loose powders, liquids, or liquid concentrates. While these forms are generally ready to mix, or in the case of liquid compositions, require no mixing, they each have disadvantages. Powdered compositions can spill, be messy to measure, and may be difficult to dispense into a vessel with a narrow opening, as is typical for many infant nursing bottles. Liquid compositions are not as convenient to transport and generally lack the same shelf life as powdered formulations. Once a sealed container of liquid formula is opened, it must be used within a short period of time or refrigerated. Additionally, liquid formulations can be subject to spilling easily during transport, and may pose difficulties during airline travel due to restrictions on permissible liquid volumes.

Accordingly, there is a need for nutritional compositions in a compressed solid form, which are easily dispensed, readily reconstituted and have a long shelf life.

### BRIEF SUMMARY

The present disclosure provides a nutritional composition in a compressed solid form, such as a tablet or a cube. In certain embodiments, the composition comprises about 21 to about 35% by weight of protein, about 20 to about 30% by weight percent of fat, and about 40 to about 60% by weight percent of carbohydrate. In particular embodiments, the compositions comprise a certain porosity, depending on the desired hardness and dissolution time. For example, the compositions have a porosity of less than about 30% in some embodiments, or greater than about 60% in other embodiments.

In certain embodiments, the composition further comprises a source of long chain polyunsaturated fatty acids, a prebiotic composition comprising polydextrose and galacto-oligosaccharide, nucleotides, vitamins and minerals. In further embodiments, the nutritional composition comprises a probiotic.

The present disclosure further processes for preparing compressed solid nutritional compositions. In certain embodiments, the compositions can be prepared by compressing a powdered nutritional composition under relatively low compression pressures. For example, a compressed solid nutritional composition is prepared by compressing a powdered nutritional composition at a pressure of less than 400 psi. The present process, in certain embodiments, further comprises contacting the powdered formula with steam prior to the compressing step.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth herein below. Each example is provided by way of explanation of the nutritional composition of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

“Nutritional composition” means a substance or formulation that satisfies at least a portion of a subject's nutrient requirements. The terms “nutritional(s)”, “nutritional formula (s)”, “enteral nutritional(s)”, “nutritional composition(s)”, and “nutritional supplement(s)” are used interchangeably throughout the present disclosure to refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults, such as women who are lactating or pregnant.

The term “enteral” means through or within the gastrointestinal, or digestive, tract. “Enteral administration” includes oral feeding, intragastric feeding, transpyloric administration, or any other administration into the digestive tract.

“Pediatric subject” means a human that is less than 13 years of age. In some embodiments, a pediatric subject refers to a human subject that is less than 8 years old. In other embodiments, a pediatric subject refers to a human subject between 1 and 6 years of age. In still further embodiments, a pediatric subject refers to a human subject between 6 and 12 years of age.

“Infant” means a subject having an age of not more than about one year and includes infants from 0 to about 12 months. The term infant includes full term infants, pre-term infants, low birth weight infants (infants weighing less 2500 g at birth), very low birth weight infants (infants weighing less than 1500 g at birth), and extremely low-birth weight infants (infants weighting less than 1000 g at birth). “Preterm” means an infant born before the end of the 37^{th} week of gestation, while “full term” means an infant born after the end of the 37^{th} week of gestation.

“Child” means a subject ranging in age from about 12 months to about 13 years. In some embodiments, a child is a subject between the ages of 1 and 12 years old. In other embodiments, the terms “children” or “child” refer to subjects that are between about one and about six years old, or between about seven and about 12 years old. In other embodiments, the terms “children” or “child” refer to any range of ages between about 12 months and about 13 years.

“Children's nutritional product” refers to a composition that satisfies at least a portion of the nutrient requirements of a child. A growing-up milk is an example of a children's nutritional product.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Milk-based” means comprising at least one component that has been drawn or extracted from the mammary gland of a mammal. In some embodiments, a milk-based nutritional composition comprises components of milk that are derived from domesticated ungulates, ruminants or other mammals or any combination thereof. Moreover, in some embodiments, milk-based means comprising bovine casein, whey, lactose, or any combination thereof. Further, “milk-based nutritional composition” may refer to any composition comprising any milk-derived or milk-based product known in the art.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant.

A nutritional composition that is “nutritionally complete” for a term infant will, by definition, provide qualitatively and quantitatively adequate amounts of all carbohydrates, lipids, essential fatty acids, proteins, essential amino acids, conditionally essential amino acids, vitamins, minerals, and energy required for growth of the term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

“Nutritional supplement” or “supplement” refers to a formulation that contains a nutritionally relevant amount of at least one nutrient. For example, supplements described herein may provide at least one nutrient for a human subject, such as a lactating or pregnant female.

“Probiotic” means a microorganism with low or no pathogenicity that exerts a beneficial effect on the health of the host.

“Prebiotic” means a non-digestible food ingredient that beneficially affects the host by selectively stimulating the growth and/or activity of one or a limited number of beneficial gut bacteria in the digestive tract, selective reduction in gut pathogens, or favorable influence on gut short chain fatty acid profile that can improve the health of the host.

All percentages, parts and ratios as used herein are by weight of the total formulation, unless otherwise specified.

Compositions of the present disclosure may be free of substantially free of any optional or selected ingredients described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All references to singular characteristics or limitations of the present disclosure shall include the corresponding plural characteristic or limitation, and vice versa, unless otherwise specified or clearly implied to the contrary by the context in which the reference is made.

As used herein, the term “about” should be construed to refer to both of the numbers specified in any range. Any reference to a range should be considered as providing support for any subset within that range.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

The present disclosure provides nutritional compositions in a compressed solid form, and processes for making them. The compressed solid forms are capable of improving the ease of use of nutritional compositions, such as infant formulas and growing-up milks. More particularly, the compressed solid forms provide for easy delivery and reconstitution when combined with water.

In a particular embodiment, the compressed solid nutritional composition comprises about 21 to about 35% by weight of protein, about 20 to about 30% by weight of a fat, and about 40 to about 60% by weight of a carbohydrate. In a particular embodiment, the compressed solid nutritional composition comprises about 25 to about 30% by weight of protein, about 22 to about 28% by weight of fat, and about 45 to about 50% by weight of fat. The compressed solid nutritional compositions are, in certain embodiments, prepared from powdered nutritional compositions. Powdered nutritional compositions include, without limitation, children's nutritional products, such as infant formula and growing-up milks, as well as adult nutritional compositions. In particular embodiments, the nutritional composition is an infant formula or a growing-up milk.

The porosity of the compressed solid can be adjusted depending on the desired properties of the final product. For example, a higher porosity compressed solid composition is capable of dissolving more rapidly than a lower porosity compressed solid, but may not have sufficient hardness. In contrast, a lower porosity compressed solid is hard, with slower dissolution. In certain embodiments, it is preferred that the compressed solid formulation has sufficient hardness to avoid breakage during packaging and transport, while still maintaining a sufficiently rapid dissolution profile for the user's convenience. Accordingly, in certain embodiments, the compressed solid composition has a porosity of greater than about 60%, for example about 60% to 80%, or about 65 to about 70%. In alternative embodiments, the porosity is less than about 30%, for example about 10 to about 30%, or about 15 to about 25%.

The compressed solid form can be provided in any desired shape, such as a cube, tablet, sphere or disc, and can be any desired size. In one embodiment, the compressed solid form is about 5 to about 20 grams, or about 5 to about 15 grams. However, larger tablets may also be prepared. For example, in an embodiment the compressed solid form is provided as a single serving size of about 8 to 9 grams, while in another embodiment, the compressed solid is provided as a multiple serving size. An 8 to 9 gram sized compressed solid can conveniently be reconstituted in about 50 to about 70 mL of water, or about 55 to 65 mL of water, in order to provide a single liquid serving of the nutritional composition.

The compressed solid compositions provide a sufficient hardness to avoid breakage while being transported by the end-user. For example, it may be convenient, particularly in the case of infant formulas or growing up milks, to carry one or more compressed solid compositions in order to feed a pediatric subject while traveling. Unwanted breakage or crumbling of the solid may result in spilling of a portion of the serving. Accordingly, the compressed solids provided herein are, in certain embodiments, sufficiently hard to avoid breakage during travel, while being advantageously capable of dispersing or dissolving readily upon exposure to water. For example, a single serving size compressed solid is capable of dissolving in cold or room temperature water in less than 120 seconds, and more preferably, about 5 to about 90 seconds, or even about 5 to about 60 seconds.

The compressed solid nutritional composition is prepared, in certain embodiments, by compressing a powdered composition. Thus, in certain embodiments, the method conveniently uses a powdered composition that has already been prepared, and additional nutritional formula ingredients do not need to be added during the preparation of the compressed solid. In particular embodiments, the powdered composition is exposed to moisture prior to the compressing step. The moisture assists in providing a consistency that allows it to be formed into a compressed solid under the compression pressure. In certain embodiments, the source of moisture is steam. The steam also advantageously can, in some embodiments, sterilize the powdered composition prior to the compression step. In certain embodiments, the amount of moisture is sufficient for compressing under relatively low compression pressures, but is not too high so as to form a sticky mass or a paste. Steam pressure applied to the appropriate vessel can be in the range of 0.1 psi to 0.5 psi depending on the rate of adsorption desired to create the “sticky” texture for the powders. The target range for the resulting powders may range from about 4.5% moisture to about 10% based on the pressure and time exposure of the powder to the super heated steam.

In a particular embodiment, the compression pressure is selected such that the powdered can be compressed into a tablet that does not break too easily during packaging and transport, but also is able to dissolve readily in water. In certain embodiments, the compression pressure is relatively low, such as less than about 400 psi. In other embodiments, the compression pressure is about 50 to about 400 psi, or about 100 to about 350 psi. More particularly, the pressure can be, in some embodiments, about 25 psi to no more that 390 psi. The compressing step may also be used to set the desired size and shape of the compressed solid.

After the compressing step, the compressed solid composition may be, in particular embodiments, further exposed to a second treatment with steam, for example by using a steaming tunnel. The second steam treatment helps smooth the surface of the compressed solid and forms a skin on the surface of the compressed solid. In certain embodiments, the steam is super-heated steam, and the duration of exposure is short. The steam treatment to help develop the skin and provide some form of rigidity to the formed or pressed powder ranges from 3 seconds to less than 60 seconds. After this steaming step, the product is dried in an oven, preferably under vacuum, and then cooled. The resulting compressed solid compositions may then be packaged in any convenient form, such as foil sachets or blister packs.

An exemplary embodiment of the process for preparing a compressed solid nutritional composition includes the following steps. A powdered nutritional composition, such as an infant formula or a growing-up milk, is provided in a reaction vessel and steam is then introduced into the vessel to moisten the powder. The moist powder is at a consistency to allow the powder to be formed into the desired shape during the compressing step. The moistened powder is then compressed under a low compression pressure into cubes or tablets. The formed cubes are then passed through a steaming tunnel to provide a skin on the surface the cubes. The skin provides a smooth surface and helps prevent breakage of the cubes. The steam in this step is superheated, and the exposure time to the steam is very short. The cubes are then dried in an oven and cooled prior to packaging under an inert gas.

In some embodiments, the disclosure provides a fortified milk-based growing-up milk designed for children ages 1-3 years and/or 4-6 years, wherein the growing-up milk supports growth and development and life-long health. In some embodiments, the disclosure provides an infant formula suitable for infants ranging in age from 0 to 12 months, or from 0 to 3 months, 0 to 6 months or 6 to 12 months.

Suitable fat or lipid sources for the nutritional composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

Carbohydrate sources can be any used in the art, e.g., lactose, glucose, fructose, corn syrup solids, maltodextrins, sucrose, starch, rice syrup solids, and the like. The amount of carbohydrate in the nutritional composition typically can vary from between about 5 g and about 25 g/100 kcal.

The nutritional composition(s) of the disclosure may also comprise a protein source. In some embodiments, the nutritional composition comprises between about 1 g and about 7 g of a protein source per 100 kcal. The protein source can be any used in the art, e.g., nonfat milk, whey protein, casein, soy protein, hydrolyzed protein, amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In one embodiment, the proteins of the nutritional composition are provided as intact proteins. In other embodiments, the proteins are provided as a combination of both intact proteins and partially hydrolyzed proteins. For example, partially hydrolyzed proteins have, in some embodiments, a degree of hydrolysis between about 4% and about 10%. In certain other embodiments, the proteins are more completely hydrolyzed. In still other embodiments, the protein source comprises amino acids. In yet another embodiment, the protein source may be supplemented with glutamine-containing peptides. In particular embodiments, exogenous lysine is not included in the nutritional composition.

In a particular embodiment of the nutritional composition, the whey:casein ratio of the protein source is similar to that found in human breast milk. In an embodiment, the protein source comprises from about 40% to about 805% whey protein and from about 20% to about 60% casein.

In one embodiment, the nutritional composition may contain one or more probiotics. Any probiotic known in the art may be acceptable in this embodiment. In a particular embodiment, the probiotic may be selected from any Lactobacillus species, Lactobacillus rhamnosus GG (e.g., ATCC number 53103), Bifidobacterium species, Bifidobacterium longum (e.g. AH1205 or AH1206), and Bifidobacterium animalis subsp. lactis BB-12 (DSM No. 10140), Bifidobacterium infantis (e.g. 35624), or any combination thereof.

If included in the composition, the amount of the probiotic may vary from about 1×10⁴ to about 1×10¹² colony forming units (cfu) per gram of the nutritional composition. In another embodiment, the amount of the probiotic may vary from about 1×10⁶ to about 1×10¹² cfu per gram of the nutritional composition. In still another embodiment, the amount of the probiotic may vary from about 1×10⁶ to about 1×10⁹ cfu per gram of the nutritional composition, or about 1×10⁹ to about 1×10¹² cfu per gram of the nutritional composition. In yet another embodiment, the amount of the probiotic may be at least about 1×10⁶ cfu per gram of the nutritional composition.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such new source is now known or later developed.

The nutritional composition may also contain one or more prebiotics in certain embodiments. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose.

More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides.

In an embodiment, the total amount of prebiotics present in the nutritional composition may be from about 1.0 g/L to about 10.0 g/L of the composition on a ready to feed basis. For example, in some embodiments, PDX may be included in the nutritional composition in an about of about 1.0 to 10. g/L. In another embodiment, the amount of PDX is about 2.0 to about 8.0 g/L.

In certain embodiments, at least 20% of the prebiotics can comprise GOS, PDX or a mixture thereof. In an embodiment, the PDX and GOS have a PDX:GOS ratio of between about 9:1 and 1:9. In another embodiment, the ratio of PDX:GOS can be about 5:1 to 1:5. In yet another embodiment, the ratio of PDX:GOS can be between about 1:3 and 1:3. In further more particular embodiments, the ratio can be about 1:1 or 4:1. In another embodiment, the amount of the PDX:GOS combination may be between about 2.0 g/L and 8.0 g/L. In a particular embodiment, the amount of the PDX:GOS combination may be about 2 g/L of PDX and 2 g/L of GOS. At least 20% of the prebiotics can comprise GOS, PDX, or a mixture thereof. The amount of each of GOS and/or PDX in the nutritional composition may, in an embodiment, be within the range of from about 1.0 g/L to about 4.0 g/L. In other embodiments, the amount GOS and/or PDX is about 1 to about 10 g/100 kcal, about 2 to about 10 g/100 kcal, or about 4 to about 8 g/100 kcal of the powdered formulation.

The nutritional composition of the disclosure may contain a source of long chain polyunsaturated fatty acid (LCPUFA) that comprises docosahexaenoic acid. Other suitable LCPUFAs include, but are not limited to, α-linoleic acid, γ-linoleic acid, linoleic acid, linolenic acid, eicosapentaenoic acid (EPA) and arachidonic acid (ARA).

In an embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The nutritional composition may be supplemented with oils containing DHA and/or ARA using standard techniques known in the art. For example, DHA and ARA may be added to the composition by replacing an equivalent amount of an oil, such as high oleic sunflower oil, normally present in the composition. As another example, the oils containing DHA and ARA may be added to the composition by replacing an equivalent amount of the rest of the overall fat blend normally present in the composition without DHA and ARA.

If included, the source of DHA and/or ARA may be any source known in the art such as marine oil, fish oil, single cell oil, egg yolk lipid, and brain lipid. In some embodiments, the DHA and ARA are sourced from single cell Martek oils, DHASCO® and ARASCO®, or variations thereof. The DHA and ARA can be in natural form, provided that the remainder of the LCPUFA source does not result in any substantial deleterious effect on the subject. Alternatively, the DHA and ARA can be used in refined form.

In an embodiment, sources of DHA and ARA are single cell oils as taught in U.S. Pat. Nos. 5,374,657; 5,550,156; and 5,397,591, the disclosures of which are incorporated herein in their entirety by reference. Nevertheless, the present disclosure is not limited to only such oils.

The nutritional composition may also comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. (Stone B A, Clarke A E. Chemistry and Biology of (1-3)-Beta-Glucans. London:Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000; 120:413-431.)

β-1,3-glucans are naturally occurring polysaccharides, with or without β-1,6-glucose side chains that are found in the cell walls of a variety of plants, yeasts, fungi and bacteria. β-1,3; 1,6-glucans are those containing glucose units with (1,3) links having side chains attached at the (1,6) position(s). β-1,3; 1,6 glucans are a heterogeneous group of glucose polymers that share structural commonalities, including a backbone of straight chain glucose units linked by a β-1,3 bond with β-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

The nutritional composition(s) of the present disclosure may further comprises, in certain embodiments, nucleotides, including without limitation, cytidine 5′-monophosphate, uridine 5′monophosphate, adenosine 5′-monophosphate, guanosine 5′monophosphate, and mixtures thereof.

In an embodiment, the nutritional composition(s) of the present disclosure comprises choline. Choline is a nutrient that is essential for normal function of cells. It is a precursor for membrane phospholipids, and it accelerates the synthesis and release of acetylcholine, a neurotransmitter involved in memory storage. Moreover, though not wishing to be bound by this or any other theory, it is believed that dietary choline and docosahexaenoic acid (DHA) act synergistically to promote the biosynthesis of phosphatidylcholine and thus help promote synaptogenesis in human subjects. Additionally, choline and DHA may exhibit the synergistic effect of promoting dendritic spine formation, which is important in the maintenance of established synaptic connections. In some embodiments, the nutritional composition(s) of the present disclosure includes about 40 mg choline per serving to about 100 mg per 8 oz. serving.

In an embodiment, the nutritional composition comprises a source of iron. In an embodiment, the source of iron is ferric pyrophosphate, ferric orthophosphate, ferrous fumarate or a mixture thereof and the source of iron may be encapsulated in some embodiments.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In certain embodiments, the composition may optionally include one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In other embodiments, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound. However, in particular embodiments, the compositions do not include manganese gluconate, copper carbonate or zinc oxide.

The minerals can be added to growing-up milks or to other children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

The amounts of vitamins and minerals in the children's nutritional composition may vary on a country by country basis. In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

The children's nutritional composition of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The nutritional compositions of the disclosure may provide minimal, partial or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals. The amount of lipid or fat typically can vary from about 2 to about 7 g/100 kcal. The amount of protein typically can vary from about 1 to about 5 g/100 kcal. The amount of carbohydrate typically can vary from about 8 to about 14 g/100 kcal.

In some embodiments, the nutritional composition of the present disclosure is a growing-up milk. Growing-up milks are fortified milk-based beverages intended for children over 1 year of age (typically from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of an infant formula or a growing-up milk or other nutritional composition according to the present disclosure can vary from country to country, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition is typically derived from the milk raw materials. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels that depend on the nutrient contribution of regional cow's milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

Examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the example, be considered to be exemplary only, with the scope and spirit of the disclosure being indicated by the claims which follow the example.

### Example

### Preparation of an Infant Formula Tablet

A commercially available powdered infant formula is introduced into a reactor vessel, in which pressured hot air is introduced from the bottom to stir the powder. After circulating the air, steam is injected into the vessel to moisten the powder. The pressure is held and the temperature is increased slightly and mechanical agitation is continued. The vessel is then subjected to vacuum pressure, for example to 30 mmHG and the negative pressure is held for a period of time and then released. The moistened product is then compressed into a compressed solid using a compression machine to provide a tray of compressed solid infant formula in single serving (8-9 g) portions. The compressed solid product is dried in a vacuum oven for a period of time and cooled, and then packaged into foil sachets under nitrogen gas.

1. A nutritional composition in a compressed solid form comprising:
about 21 to about 35% by weight of protein,
about 20 to about 30% by weight percent of fat, and
about 40 to about 60% by weight percent of carbohydrate,
wherein the porosity of the compressed solid is less than about 30% or greater than about 60%, and the compressed solid has a moisture level of greater than 40%,
the compressed solid form is prepared by i) contacting a powdered nutritional composition with steam to provide the powder with a moisture content of about 4.5 to about 10% such that the compressed solid can be formed under at a pressure in a range from about 50 to about 400 psi, ii) compressing a powdered nutritional composition at a pressure in a range from about 50 to about 400 psi, wherein the pressure provides a compressed solid form that does not break during packaging and transport and provides a compressed solid form that dissolves in 60 mL of water in less than 120 seconds and iii) treating the compressed solid form with steam to provide a smooth surface on the compressed solid form.

2. The nutritional composition of claim 1, wherein the moisture level of the compressed solid form is in a range of about 40 to about 60%.

3-4. (canceled)

5. The nutritional composition of claim 1, which is an infant formula or a growing-up milk.

6. The nutritional composition of claim 1, wherein the compressed solid form is provided a single serving size of about 8 to about 9 grams.

7. (canceled)

8. The nutritional composition of claim 1, further comprising about 5 to about 200 mg/100 kcal of a source of long chain polyunsaturated fatty acids.

9. The nutritional composition of claim 8, wherein the source of long chain polyunsaturated fatty acids comprises docosahexaenoic acid and arachidonic acid.

10. The nutritional composition of claim 8, wherein the source of long chain polyunsaturated fatty acids comprises docosahexaenoic acid and arachidonic acid in a ratio of about 1:3 to about 9:1.

11. The nutritional composition of claim 1, further comprising about 1 to about 10 g/100 kcal of a prebiotic composition, wherein the prebiotic composition comprises polydextrose and galacto-oligosaccharide.

12. The nutritional composition of claim 11, wherein the polydextrose and galacto-oligosaccharide have ratio of between about 1:3 and 3:1.

13. The nutritional composition of claim 1, further comprising at least one probiotic.

14. (canceled)

15. A process for preparing a nutritional composition in a compressed solid form comprising:
contacting a powdered nutritional composition with steam such that the powder has a moisture content of about 4.5 to about 10%,
compressing the powdered nutritional composition under a pressure of about 50 to about 400 psi to provide the compressed solid form, and
treating the compressed solid form with steam to provide a smooth surface on the compressed solid form,
wherein the compressed solid form has a moisture content of at least 40%.

16. The process of claim 15, wherein the nutritional composition comprises:
about 21 to about 35% by weight of protein,
about 20 to about 30% by weight of fat, and
about 40 to about 60% by weight of carbohydrate.

17. The process of claim 15, wherein the nutritional composition is an infant formula or a growing-up milk.
